(19) United States
(12) Patent Application Publication
(10) Pub. No.: US 2021/0088540 A1
(43) Pub. Date: Mar. 25, 2021

(54) CORRECTIVE ACTIONS IN RESPONSE TO PAUSE SIGNALS

(71) Applicant: HEWLETT-PACKARD DEVELOPMENT COMPANY, L.P., Spring, TX (US)

(72) Inventors: David H. OCHS, Corvallis, OR (US); Jeffrey A. NIELSEN, Corvallis, OR (US); Christie DUDENHOEFER, Corvallis, OR (US)

(21) Appl. No.: 16/603,671

(22) PCT Filed: Sep. 27, 2017
(86) PCT No.: PCT/US2017/053716

§ 371 Date: Oct. 8, 2019

(51) Int. Cl. G01N 35/00

(52) U.S. Cl. CPC G01N 35/00623

(57) ABSTRACT

In example implementations, a method is provided. The method may be executed by a processor of a fluid dispensing apparatus. The method includes detecting a pause signal due to a surface load error. Corrective actions are initiated in response to the pause signal. A continue signal is received after the corrective actions are completed and a correct microplate is loaded into the fluid dispensing apparatus. Fluids are then dispensed into wells of the correct microplate.

### BACKGROUND

Laboratories often run experiments using various different liquids to obtain different types of experimental data. The experiments may use microplates or microtiter plates to perform titrations on the various different liquids.

Microplates may include a plurality of wells arranged in a rectangular matrix. The microplates may have any number of wells, from as little as six to as many as 1536. The microplates may be handled by robots during dispensing of liquids into the wells to prevent contamination and to dispense precise amounts of desired liquids into particular wells during execution of the experiments.

### BRIEF DESCRIPTION OF THE DRAWINGS

FIG. 1 is a block diagram of an example fluid dispensing apparatus of the present disclosure;

FIG. 2 is a functional block diagram of an example fluid dispensing apparatus of the present disclosure;

FIG. 3 illustrates an example graphical user interface (GUI) of the present disclosure;

FIG. 4 is a flow chart of an example method for performing corrective actions in response to a surface load error; and

FIG. 5 is a block diagram of an example non-transitory computer readable storage medium storing instructions executed by a processor.

### DETAILED DESCRIPTION

Examples described herein provide an apparatus and a method for initiating corrective actions in response to load errors of microplates. As discussed above, microplates may be used in various industries to run lab experiments that involve liquids. The microplates may be handled by robots or machines to prevent contamination and dispense precise amounts of liquids into particular wells of the microplate during execution of the experiments.

Currently, when a load error of the microplate is detected, the operator has no way of suspending the dispensing progress to the wells of the incorrectly loaded microplate. The operator has no way of pausing the apparatus to remove the incorrectly loaded microplate, inserting the correct microplate, and collecting data with regards to which wells may have received incorrect fluids. As a result, entire days, or weeks, worth of experiments may be ruined.

Examples described herein provide an apparatus that is modified with a pause button that can be pressed to activate or initiate corrective actions. For example, signals may be generated in response to the pause button being pressed to initiate corrective actions, such as suspending or stopping dispensing of fluids, allowing physical access to remove the incorrectly loaded surface (e.g., a microplate or experimental surface), generating a graphical user interface to collect various user provided data, and recording various operational data that can be included in a final report. The user provided data and the operational data can then be used to correctly resume dispensing of fluids to a correctly loaded surface and to identify those wells in the incorrectly loaded surface that may be compromised.

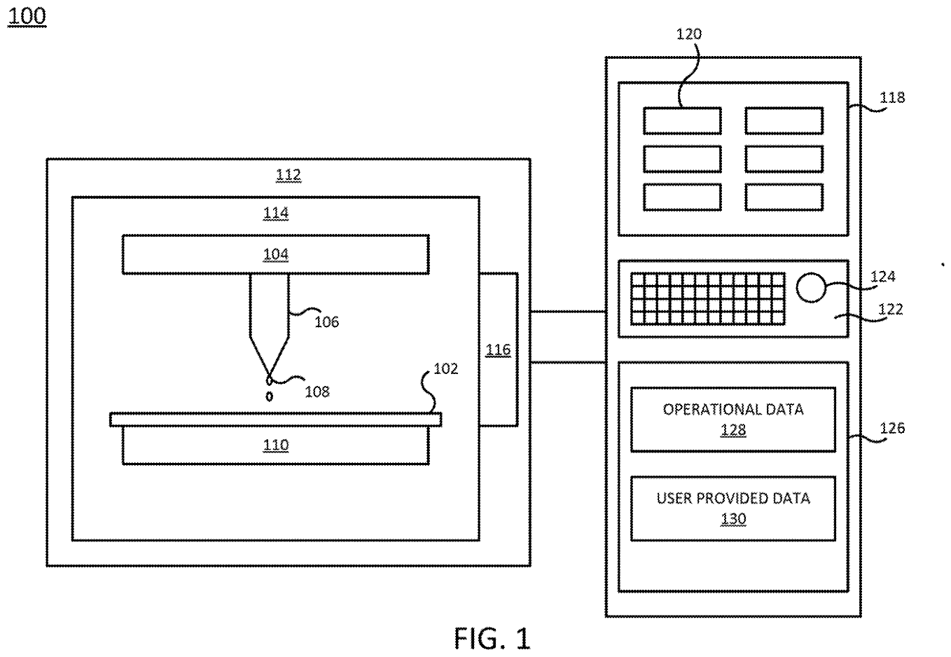

FIG. 1 illustrates a block diagram of an example fluid dispensing apparatus 100 of the present disclosure. In one example, the fluid dispensing apparatus may include a fluid dispensing system 104 and a platform 110 that holds a surface 102. The fluid dispensing system 104 may include any type of dispenser such as a thermal inkjet dispenser with a cassette and dispense heads, a digital pipette system, an acoustic dispensing system, a pressure based dispensing system, a metering fluid dispense system, and the like. Although the present disclosure is discussed with respect to one example that uses a thermal inkjet with a nozzle, the present disclosure may be applicable to any type of fluid dispensing system.

In one example, the fluid dispensing system 104 may include a nozzle 106 that dispenses a fluid 108. Although a single nozzle 106 is illustrated in FIG. 1, it should be noted that the fluid dispensing system 104 may include a plurality of different nozzles 106. The different nozzles 106 may be the same shape and size or may be different shapes and sizes (e.g., diameter openings of the nozzle).

In one example, the fluid dispensing system 104 may be a thermal inkjet printhead. For example, the thermal inkjet printhead traditionally used to dispense ink in a printer may be modified to deliver and dispense fluids (e.g., chemical liquids such as a solvent or aqueous-based pharmaceutical compounds, as well as aqueous-based biomolecules including proteins, enzymes, lipids, antibiotics, mastermix, DNA samples, cells, or blood components, all with optional additives, such as surfactants or glycerol, and the like).

The fluid dispensing system 104 may dispense different types of fluids from respective reservoirs (not shown) of the different types of fluids. The fluid dispensing system 104 may be deployed on a movable platform that can move the nozzle 106 to a desired location within a two dimensional grid over the surface 102.

In one example, the surface 102 may be a microplate fabricated from plastic or glass. The microplate may include a plurality of wells that can each hold the fluid 108. The fluid 108 may be dispensed into particular wells of the microplate to execute titration experiments.

In another example, the surface 102 may be an experimental surface that can be used to grow a bio-mass or deposit patterned layers of matter and the fluid 108. In other examples, the surface 102 may be a mounted paper, a surface containing electric sensors, and the like. Although a single surface 102 is illustrated in FIG. 1, the fluid dispensing apparatus 100 may hold any number of surfaces 102.

In one example, the platform 110 may also move along a two dimensional coordinate system. For example, the platform 110 may move into a position such that a particular location of the surface 102 may receive the fluid 108 from the nozzle 106. For example, the surface 102 may be positioned below the nozzle 106. In other examples, the surface 102 may be positioned above the nozzle 106.

In one example, the fluid dispensing apparatus 100 may include a housing 112 that encloses the fluid dispensing system 104, the surface 102, and the platform 110. The housing 112 may be fabricated from an optically clear plastic or glass such that a user or an operator may view operation of the fluid dispensing system 104.

The housing 112 may include an access way 114. The access way 114 may provide an opening fora user to access the microplate 102. For example, the access way 114 may be an automated door or a slotted opening that allows the surface 102 to be pushed out to the user or inserted into the fluid dispensing apparatus 100. In another example, the access way 114 may include presenting the surface 102. For example, an arm, a portion of the fluid dispensing system 104, a clamp holding the surface 102, and the like may be moved out of the way such that the surface 102 can be accessed.

Different surfaces 102 may be removed from or inserted into the fluid dispensing apparatus 100 via the access way 114. The access way 114 may be coupled to an automated device 116 that allows the access way 114 to provide access to the surface 102. When the access way 114 is a door, the automated device 116 may be an electro-mechanical device or an electro-magnetic device that opens or closes the door via an electrical signal. When the access way 114 is a slot or opening, the automated device 116 may be an actuated arm or track system that moves the surface 102 out and through the opening. As discussed in further detail below, the automated device 116 may be controlled to automatically provide access to the surface 102 via the access way 114 as part of a corrective action.

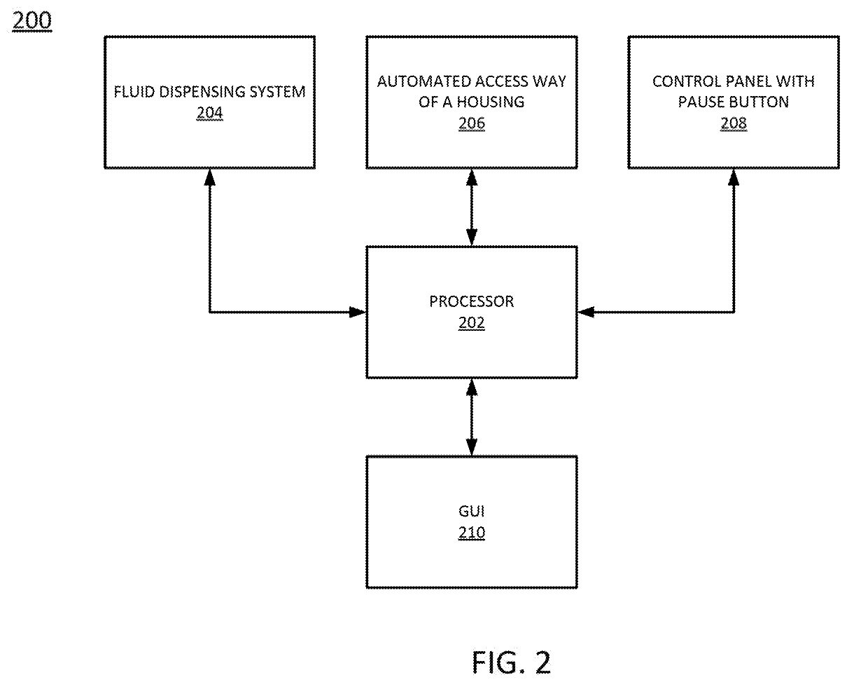

The fluid dispensing apparatus 100 may also include a display 118, a control panel 122 and a memory 126 that are each in communication with a processor (illustrated in FIG. 2 and discussed below) that controls operation of the fluid dispensing apparatus 100. The display 118 may be touch display or a non-touch display. The display 118 may display a graphical user interface (GUI) 120 that can be used to display prompts, information, current progress of the fluid dispensing system 104, current progress of an experimental recipe (e.g., a program that is executed by the fluid dispensing apparatus 100 that specifies which fluids 108 are to be dispensed into which locations of the surface 102, at which times the fluids 108 are to be dispensed, an amount of each fluid 108 that is to be dispensed into each location of the surface 102, and the like) that is being executed, collect user provided data 130, and the like.

In one example, the control panel 122 may include a pause button 124 as well as other control buttons. The control panel 122 and the pause button 124 may be a software interface that is part of a touch screen of the GUI 120. In another example, the control panel and the pause button 124 may be deployed as physical buttons and include additional knobs and ports (e.g., a keyboard, a touch pad, universal serial bus (USB) ports, and the like). When a user or technician detects a surface load error (e.g., the wrong microplate has been loaded onto the platform 110 for a particular experimental recipe), the user may press the pause button 124. In response, a pause signal may be generated by the pause button 124 that causes a corrective action or actions to be executed by the fluid dispensing apparatus 100 in response to the pause signal.

In one example, the corrective actions may include pausing or suspending the fluid 108 from being dispensed by the fluid dispensing system 104. The fluid dispensing system 104 may activate the automated device 116 to open the access way 114.

The corrective actions may include prompting a user via the GUI 120 to provide the user provided data 130. In one example, the user provided data 130 may include identification information associated with the incorrect microplate, identification of an experimental recipe that was being executed, when the surface load error was detected (e.g., which step during the experimental recipe), and the like.

The corrective actions may also include modifying a sequence of surfaces 102 that may be used for the experimental recipe. For example, the GUI 120 may display what surface 102 is expected to be used next. However, since the incorrect surface was loaded, the user may modify the next surface to be the correct surface that was supposed to be loaded. To illustrate, the experimental recipe may believe it is dispensing fluids into locations of a second surface of four surfaces.

However, due to the surface load error the third surface may have been loaded. In one example, the user may remove the third surface and load the correct second surface. The GUI 120 may indicate that the third surface was incorrectly loaded and that the correct second surface has now been loaded. The user may also use the GUI 120 to change the sequence of the surfaces such that the next surface is the third surface rather than the second surface. Then, when the correct second surface is loaded the experimental recipe may correctly dispense fluids into the second surface.

In another example, the user may change the sequence such that the current surface (which may have been incorrectly loaded) is the “correct” surface that is currently loaded. In other words, the user may instruct the fluid dispensing apparatus 100 via the GUI 120 that the “incorrect” surface is the “correct” surface and leave the “incorrect” surface in the fluid dispensing system 104. The fluid dispensing apparatus 100 may change, adjust, or modify the experimental recipe to dispense the correct fluids 108 in the remaining locations for the currently loaded surface. For example, if the incorrect fluids 108 were dispensed onto the first 10 locations, the experimental recipe may be adjusted for the dispensing protocol of the currently loaded surface such that the correct fluid 108 is dispensed onto the remaining locations of the incorrect surface that was loaded.

In some examples, the user may change a sequence of the surfaces 102 that are used for an experimental recipe for reasons other than a surface load error. For example, the surface sequence modification feature may be used at any time to change the sequence of surfaces that are used for a particular experimental recipe. When the sequence is changed, the fluid dispensing apparatus 100 may then change an order of fluids 108 that are dispensed and modify the experimental recipe to accommodate the sequence changes.

In one example, the corrective actions may include collecting operational data 128. The operational data 128 may be midstream data that may be recorded for later display or presentation to a user at a time the pause signal is detected. For example, operational data from a time that the experimental recipe started executing to the time the pause signal was detected may be recorded and stored in the memory 126. The operational data 128 may include information such as which fluids 108 were dispensed, which wells of the incorrect surface 102 received which fluids 108, a volume of each one of the fluids 108 that were dispensed, and the like. The operational data 128 that is stored may then be added to a complete operational report that is generated when the experimental recipe is completed. The operational data 128 that is recorded mid-stream when the pause signal is detected may be used to identify potentially compromised locations of the incorrect surface 102.

The user may remove the incorrect surface 102 and insert a correct surface 102 onto the platform 110 via the access provided by the access way 114. The pause button 124 may be pressed again to generate a continue signal to continue execution of an experimental recipe using the correct surface 102. For example, when the pause button 124 is pressed while the fluid dispensing apparatus 100 is in a corrective action state, the fluid dispensing apparatus 100 may generate the continue signal. On the other hand, when the pause button 124 is pressed while the fluid dispensing apparatus 100 is in an operational state (e.g., dispensing the fluid 108), the fluid dispensing apparatus 100 may generate the pause signal.

In one example, the fluid dispensing apparatus 100 may re-run a portion of the experimental recipe in response to detecting the continue signal, such that any dispense that occurred while the incorrect surface 102 was loaded can be redone on the correct surface 102. In another example, the fluid dispensing apparatus 100 may perform various actions based on the operational data 128 and the user provided data 130. For example, the fluid dispensing apparatus 100 may determine how much of each fluid 108 was dispensed and refill, or request the user to refill, or top-off, respective reservoirs of the fluid to ensure that enough fluid 108 is available to execute the experimental recipe to completion on the correct surface 102. The fluid dispensing apparatus 100 may determine how much time has elapsed since dispensing of fluids 108 in each well of the correct surface 102 due to the surface load error and reprioritize dispensing fluid 108 into certain wells that may have time sensitive titrations or reactions.

In one example, after the experimental recipe is executed, the fluid dispensing apparatus 100 may generate a full report. The full report, the operational data 128 and the user provided data 130 may then be used by technicians to identify those wells in the incorrect surface 102 that may have been compromised. In one example, the operational data 128 and the user provided data 130 may be sufficient to identify those wells in the incorrect surface 102 that may have been compromised.

For example, the technician may use the operational data 128 to identify how much of each fluid 108 may have been dispensed in the compromised wells to possibly perform corrections. At a minimum, the technician may be allowed to collect data from successfully completed experiments and identify those wells in the incorrect microplates that may have been compromised rather than restarting the experiments for both the incorrect microplate and the correct microplate. Thus, the corrective actions executed by the fluid dispensing apparatus 100 in response to the pause signal during operation may allow in progress experiments to continue, which can save hours or days of experimental work.

FIG. 2 illustrates a functional block diagram of an example fluid dispensing apparatus 200. In one example, the fluid dispensing apparatus 200 may be the same as the fluid dispensing apparatus 100.

In one example, the fluid dispensing apparatus 200 may include a processor 202, a fluid dispensing system 204, an automated access way of a housing 206, a control panel with a pause button 208 and a GUI 210. In one example, the fluid dispensing system 204, the automated door of the housing 206, the control panel with the pause button 208 and the GUI 210 may each be communicatively coupled to the processor 202. In other words, the processor 202 may send and receive electrical signals to and from the fluid dispensing system 204, the automated access way of the housing 206, the control panel with the pause button 208 and the GUI 210.

In one example, the fluid dispensing apparatus 200 may include a microplate platform (e.g., the microplate platform 110) that is located below the fluid dispensing system 204. When a surface load error is detected (e.g., the incorrect microplate has been loaded onto the microplate platform) a technician may press the pause button. As a result, the control panel with the pause button 208 may generate a pause signal when depressed due to the surface load error.

The pause signal may be received by the processor 202. In response to receiving the pause signal, the processor 202 may perform corrective actions associated with the fluid dispensing system 204, the automated door of the housing 206, the GUI 210 and recording data. In one example, the corrective actions may include pausing operation of the fluid dispensing system 204. For example, the processor 202 may send a control signal to the fluid dispensing system 204 to stop dispensing fluid into the incorrect microplate.

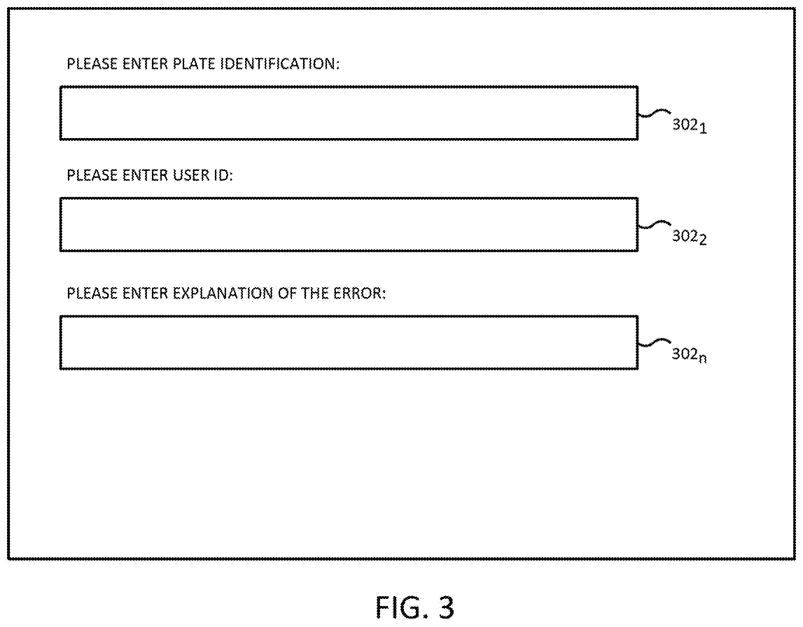

In addition, the processor 202 may cause the GUI 210 to display prompts to collect user provided data (e.g., the user provided data 130). FIG. 3 illustrates an example of the GUI 120 or 210. In one example, the GUI 120 or 210 may include a plurality of data entry fields 302₁ to 302ₙ (hereinafter referred to individually as a data entry field 302 or collectively as data entry fields 302). The data entry fields 302 may prompt the user to enter information that is stored as the user provided data 130. For example, the data entry field 302₁ may ask for identification of the incorrect surface, the data entry field 302₂ may ask for the name or ID of the user initiating the pause signal, the data entry field 302ₙ may ask for an explanation of the error, and the like. It should be noted that although three data entry fields 302 are illustrated in FIG. 3 that the GUI 120 or 210 may display any number of data entry fields that request any type of information related to the surface load error.

Referring back to FIG. 2, the corrective actions may also include causing the automated access way of the housing 206 to open. For example, the processor 202 may send a control signal to unlock an electro-mechanical or an electro-magnetic device that can open and close the door or activate an arm or track to push the surface 102 out for access. After the automated access way of the housing 206 is opened to provide access to the surface 102, the technician may remove the incorrect surface and insert the correct surface.

The corrective actions may also include recording operational data (e.g., the operational data 128). For example, the processor 202 may collect operational data midstream (e.g., operational data from the beginning of the experimental recipe being executed to a time that the pause signal is received or detected). As noted above, the operational data may include information such as which fluids were dispensed, which wells of the incorrect microplate received which fluids, a volume of each one of the fluids that were dispensed, and the like.

After the corrective actions are executed, the technician may press the pause button again on the control panel with the pause button 208. Pressing the pause button during a corrective action state may generate a continue signal. The continue signal may be received by the processor 202. In response the processor 202 may activate the automated door of the housing 206 to close the door and activate the fluid dispensing system 204.

In one example, after the experimental recipe is completed the processor 202 may generate a completion report. In one example, the processor 202 may use the operational data 128 that was recorded midstream, the user provided data 130 and the completion report to identify which wells in which microplate may have been compromised. The processor 202 may display the identification of which wells in which microplate were compromised via the GUI 210 to the technician. The GUI 210 may provide additional information such as when the microplate error was detected, which fluids were added at what times in the identified wells, and the like.

As a result, the technician may still obtain good experimental data and know which wells of which microplate may provide incorrect experimental data. In addition, the technician may then re-execute the experiment for the identified wells in the identified microplate rather than having to re-run the entire experiment.

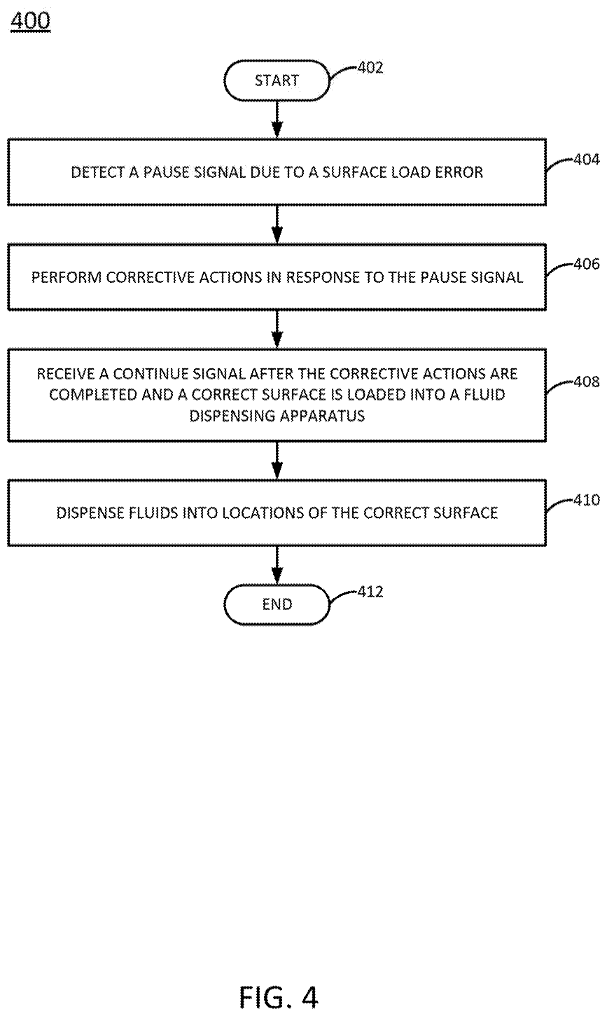

FIG. 4 illustrates a flow diagram of an example method 400 for performing corrective actions in response to a surface load error. In one example, the method 400 may be performed by the processor of the fluid dispensing apparatus 100 or the processor 202 of the fluid dispensing apparatus 200.

At block 402, the method 400 begins. At block 404, the method 400 detects a pause signal due to a surface load error. For example, a user or a technician may detect a surface load error. For example, the incorrect surface may have been loaded into the fluid dispensing apparatus for a particular experiment or experimental recipe. To prevent complete contamination in all of the locations of the incorrect surface (e.g., wells of a microplate or pattern layers of a mass grown on an experimental surface) the user may press a pause button on a control panel of the fluid dispensing apparatus that generates a pause signal while the fluid dispensing apparatus is in an operational state.

At block 406, the method 400 performs corrective actions in response to the pause signal. The corrective actions may include generating a control signal to stop the fluid dispensing system from dispensing fluids. In one example, the user may be provided with access to the surface. For example, an automated device 116 may be activated to open the door of a housing of the fluid dispensing apparatus, or the surface may be pushed through an opening or slot to allow access to the surface. The incorrect surface may then be removed and the correct surface may be loaded.

In another example, the corrective actions may include changing a sequence of surfaces of the experimental recipe. As a result, the “incorrect” surface may be left in the fluid dispensing system and the user may change the sequence such that the experimental recipe uses the dispense protocol for the “incorrect” surface that is currently in the fluid dispensing system.

A GUI of the fluid dispensing apparatus may then display prompts to receive user provided data. For example, the user provided data may include information such as identification of the incorrect surface (e.g., an ID number, bar code number, and the like), the name or ID of the user that initiated the pause signal, an explanation of the error, and the like. This information may allow someone interpreting the data at a later time to know who to ask about the error that was detected, circumstances regarding the experiment that could affect the data, and the like.

Operational data up to a time that the pause signal was detected may also be recorded. The operational data may collect midstream information from a time the experimental recipe began until the pause signal was detected.

At block 408, the method 400 receives a continue signal after the corrective actions are completed and a confirmation that a correct surface is loaded into the fluid dispensing apparatus. For example, the user may provide confirmation such that the fluid dispensing apparatus knows that the correct surface is loaded to continue the experimental recipe. The correct surface may be a different surface that the fluid dispensing apparatus was expecting, or may be the same “incorrect” surface after the user has changed the sequence of surfaces in the experimental recipe to start with the “incorrect” surface that was previously loaded.

After the fluid dispensing apparatus is told that the correct surface is loaded, the user may provide a continue signal. For example, pressing the pause button again while the fluid dispensing apparatus is in a corrective action state may generate the continue signal. In response, fluid dispensing apparatus may continue with the experimental recipe. For example, if the incorrect surface was removed, the automated door may be closed and the fluid dispensing system may be activated to continue dispensing fluids into the correctly loaded microplate.

At block 410, the method 400 dispenses fluids into locations of the correct surface. The appropriate fluids may be dispensed into the appropriate locations of the correct surface in accordance with the experimental recipe that is being executed. After dispensing of the fluids is completed, a report may be generated that includes the user provided data and the operational data to identify which locations in the incorrect surface are compromised. For example, the locations may be certain wells of a microplate or locations of a particular pattern or a layer on an experimental surface. The technician may then use the report to ensure that the data associated with the identified locations in the incorrect surface are not compiled with the experimental data results.

In another example, the fluid dispensing apparatus may use the operational data and/or the user received data to determine which locations of the incorrect surface may have been compromised. The report may then include the identification of locations of the incorrect surface that are compromised. In other words, the identification may be performed automatically by the fluid dispensing apparatus. At block 412, the method 400 ends.

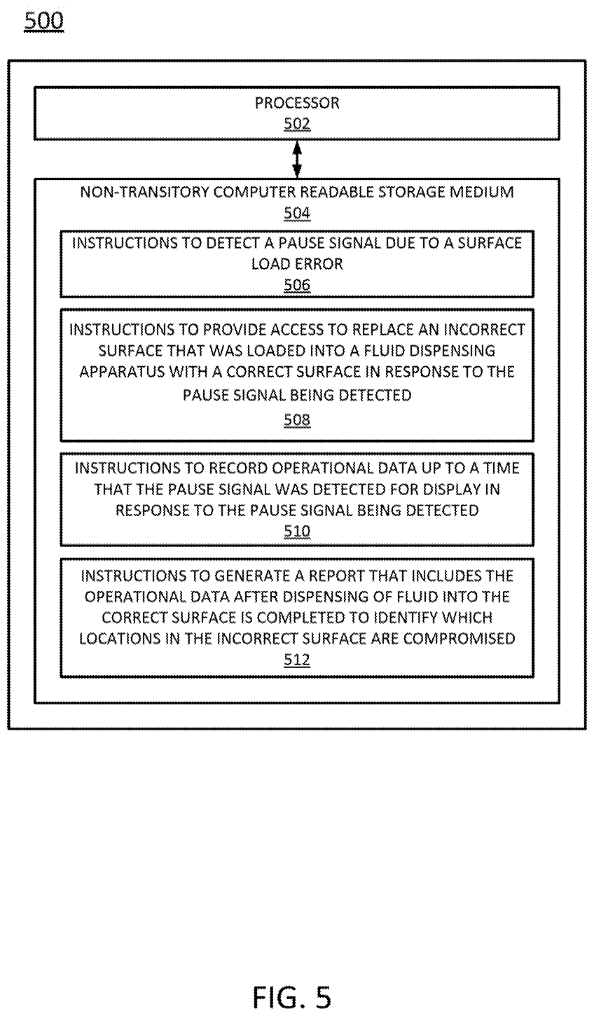

FIG. 5 illustrates an example of an apparatus 500. In one example, the apparatus 500 may be the fluid dispensing apparatus 100 or 200. In one example, the apparatus 500 may include a processor 502 and a non-transitory computer readable storage medium 504. The non-transitory computer readable storage medium 504 may include instructions 506, 508, 510, and 512, that when executed by the processor 502, cause the processor 502 to perform various functions.

The instructions 506 may include instructions to detect a pause signal due to a surface load error. For example, a user or a technician may detect a surface load error. For example, the incorrect surface may have been loaded into the fluid dispensing apparatus for a particular experiment or experimental recipe. To prevent complete contamination in all of the locations of the incorrect surface the user may press a pause button on a control panel of the fluid dispensing apparatus that generates a pause signal while the fluid dispensing apparatus is in an operational state.

The instructions 508 may include instructions to provide access to replace an incorrect surface that was loaded into the fluid dispensing apparatus with a correct surface in response to the pause signal being detected. In one example, in response to the pause signal being detected, corrective actions may be executed. The corrective actions may include stopping the fluid dispensing system from dispensing fluids and providing access to the incorrectly loaded surface. For example, a door on a housing of the fluid dispensing apparatus may be automatically opened or an arm may be activated to move the surface through an opening or slot of the housing. The technician may remove the incorrectly loaded surface and load the correct surface for a particular experimental recipe.

The instructions 510 may include instructions to record operational data up to a time that the pause signal was detected for display, in response to the pause signal being detected. Another corrective action that can be performed is to record operational data midstream. For example, the operational data may record which fluids were dispensed into which wells, how much of each fluid was dispensed into each well, an amount of time between fluids being dispensed into each well, and the like.

The instructions 512 may include instructions to generate a report that includes the operational data, after dispensing of fluids into the correct surface is completed, to identify which locations in the incorrect surface are compromised. In one example, the operational data that was recorded midstream may be sufficient to identify which locations (e.g., wells in a microplate) in the incorrect surface may be compromised.

In one example, the corrective actions may also include receiving user provided data via a GUI. The user provided data may include additional information such as an identification of the incorrect surface, the name or ID of the user that initiated the pause signal, an explanation of the error, which experimental recipe was being executed, which step of the experimental recipe was being executed when the surface load error was detected, and the like. The user provided data may be used in conjunction with the operational data to automatically generate a report that identifies the compromised locations in the incorrect surface after the experimental recipe is completed with the correct surface.

In one example, after the corrective actions are performed and the correct surface is loaded, the experimental recipe may be completely executed. In some examples, the sequence of the fluids that are dispensed into different locations of the correct surface may be based on the operational data. For example, a particular location of the correct surface may call for a particular fluid within a certain amount of time after receiving a previous fluid to ensure the reaction is carried out correctly. During normal execution of the experimental recipe, the location may receive the particular fluid after dispensing of different fluids in other locations well within the certain amount of time. However, due to the surface load error and the amount of time that has elapsed to perform the corrective actions, the particular fluid may be dispensed into the location first to ensure that the particular fluid is dispensed within the certain amount of time. In other words, modifications to the experimental recipe may be made by the fluid dispensing system based on the operational data.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
detecting, by a processor of a fluid dispensing apparatus, a pause signal due to a surface load error;
performing, by the processor, corrective actions in response to the pause signal;
receiving, by the processor, a continue signal after the corrective actions are completed and a confirmation that a correct surface is loaded into the fluid dispensing apparatus; and
dispensing, by the processor, fluids into locations of the correct surface.

2. The method of claim 1, wherein a corrective action of the corrective actions comprises providing access to an incorrect surface that was loaded into the fluid dispensing apparatus.

3. The method of claim 1, wherein a corrective action of the corrective actions comprises displaying a graphical user interface (GUI) to receive user provided data.

4. The method of claim 1, wherein the corrective action comprises changing a sequence of surfaces that are used for an experimental recipe.

5. The method of claim 1, further comprising:
generating, by the processor, a report that includes the user provided data and the operational data to identify which wells in the incorrect microplate are compromised.

6. An apparatus, comprising:
a fluid dispensing system;
a platform located below the fluid dispensing system;
a housing that encloses the fluid dispensing system and the platform,
wherein the housing comprises an access way;
a graphical user interface (GUI);
a control panel including a pause button to generate a pause signal when depressed due to a surface load error; and
a processor in communication with the fluid dispensing system, automated door, the GUI and the control panel, wherein the processor performs corrective actions associated with the fluid dispensing system, the access way, the GUI, and recording data in response to receiving the pause signal.

7. The apparatus of claim 6, wherein a corrective action associated with the fluid dispensing system comprises stopping operation of the fluid dispensing system.

8. The apparatus of claim 6, wherein the corrective action comprises changing a sequence of surfaces that are used for an experimental recipe.

9. The apparatus of claim 6, wherein a corrective action associated with the GUI comprises prompting a user to enter user provided data.

10. The apparatus of claim 6, wherein a corrective action associated with the data that is recorded comprises operational data up to a time that the pause signal was received.

11. The apparatus of claim 6, wherein the processor generates a report after the corrective actions are completed to identify which locations in an incorrect surface are compromised.

12. A non-transitory computer readable storage medium encoded with instructions executable by a processor, the non-transitory computer-readable storage medium comprising:
instructions to detect a pause signal due to a surface load error;
instructions to provide access to replace an incorrect surface that was loaded into the fluid dispensing apparatus with a correct surface in response to the pause signal being detected;
instructions to record operational data up to a time that the pause signal was detected in response to the pause signal being detected; and
instructions to generate a report that includes the operational data after dispensing of fluids into the correct surface is completed to identify which locations in the incorrect surface are compromised.

13. The non-transitory computer readable storage medium of claim 12, further comprising:
instructions to cause a display of a graphical user interface (GUI) to prompt a user to enter user provided data associated with the incorrect surface.

14. The non-transitory computer readable storage medium of claim 12, wherein the surface comprises a microplate and the locations comprises different wells of the microplate.

15. The non-transitory computer readable storage medium of claim 14, wherein a sequence of fluids that are dispensed into different locations of the correct microplate is based on the operational data.
